(19) United States
(12) Patent Application Publication
(10) Pub. No.: US 2016/0265851 A1
(43) Pub. Date: Sep. 15, 2016

(54) HEAT EXCHANGER AND METHOD FOR MANUFACTURING SAME

(71) Applicant: FLOWFORCE CO., LTD., Hwaseong (KR)

(72) Inventor: Jung Kook Seo, Siheung (KR)

(73) Assignee: FLOWFORCE CO., LTD.

(21) Appl. No.: 15/164,080

(22) Filed: May 25, 2016

Related U.S. Application Data
(63) Continuation of application No. PCT/KR2014/010422, filed on Nov. 3, 2014.

(30) Foreign Application Priority Data
Nov. 28, 2013 (KR) 10-2013-0146092

(51) Int. Cl. F28D 7/00; B23P 15/26

(52) U.S. Cl. CPC F28D 7/0066; B23P 15/26

(57) ABSTRACT

The present invention provides a heat exchange apparatus used as a cooling apparatus for hydraulic oil that operates a hydraulic machine. A heat exchange apparatus includes multiple embedded tubes through which a heat medium passes, are installed in the interior of a shell having thermal fluid, such as hydraulic oil, passing therethrough to allow a heat exchange between the heat medium and the thermal fluid. The shell of the heat exchange apparatus includes coupling the multiple tubes to closure thin plates that are a metal plate cut or bent in a predetermined shape, combining the closure thin plates in a box form, and forming a synthetic resin coating layer on the exterior surfaces of the closure thin plates. Thus, the heat exchange apparatus achieves productivity improvements and manufacturing cost reductions while ensuring performance including pressure resistance and air tightness, and durability.

### CROSS-REFERENCE TO RELATED APPLICATION

This application is a continuation application of International Application No. PCT/KR2014/010422 filed on Nov. 3, 2014, which claims priority to Korean Application No. 10-2013-0146092 filed on Nov. 28, 2013. The applications are incorporated herein by reference.

### TECHNICAL FIELD

The present invention relates to a heat exchange apparatus used as an apparatus for cooling down hydraulic oil for operating a hydraulic machine or the like and, more specifically, to a heat exchange apparatus having a plurality of tubes 20 embedded therein. The plurality of tubes 20 through which a heat medium such as a coolant passes is installed within a shell 10 through which a thermal fluid such as the hydraulic oil passes to provide heat exchange between the heat medium and the thermal fluid. The shell 10 of the heat exchange apparatus is formed by coupling the plurality of tubes 20 to closure thin plates 12, i.e., metal plates cut or bent in a predetermined shape, assembling the closure thin plates 12 in the form of a box, and forming a synthetic resin coating layer 11 on the exterior surface of the closure thin plates 12.

### BACKGROUND ART

Generally, a heat exchange apparatus for a fluid, a method of installing a plurality of tubes 20 within the interior of a shell 10 to perform heat exchange between a fluid passing through the shell 10 and a fluid passing through the tubes 20 is widely used, and Korean Patent 48150552v.1 Registration No. 1151755 is an example of the method. [Please include in Information Disclosure Statement.}

In particular, the Korean Patent Registration No. 1151755 relates to a heat exchange apparatus for cooling down hydraulic oil for operating a hydraulic machine, in which the hydraulic oil corresponds to the fluid passing through the shell 10, i.e., a thermal fluid, and a coolant corresponds to the fluid passing through the tubes 20, i.e., a heat medium.

In other words, as shown in FIGS. 2A and 2B, the thermal fluid, which is high temperature hydraulic oil flowing into the shell 10, is discharged after being cooled down while passing through the plurality of tubes 20 installed within the interior of the shell 10 by a heat exchange with the coolant flowing into the bonnet 30 through the feed-and-discharge apertures 33 and passes through the tubes 20. In the conventional heat exchange apparatus configured as described above, the shell 10 embedded with the tubes 20 is generally configured of a metal enclosure or a thick plate which requires a cutting process after being molded through a casting.

Typically, in a heat exchange apparatus, for cooling down operating oil of a hydraulic machine, the shell 10 is manufactured using a thick metal plate as shown in FIG. 1. Since the shell 10 is a pressure container through which a high pressure fluid such as operating oil of a hydraulic machine directly passes it requires sufficient pressure resistance and strength to endure the pressure of the high pressure fluid. Further, in addition to requiring a high degree airtightness, and based on the cross-sectional view shown in the upper portion of the figure, windings of a complicated shape should be formed within the shell to secure contactness between the thermal fluid passing through the shell 10 and the tubes embedded in the shell 10. Moreover, at the substantially the same time, the interior surface of the shell 10 should be smoothly processed to minimize the friction between the thermal fluid and the interior wall of the shell 10 and prevent separation of the tissues of the interior wall of the shell 10 which may occur when the heat exchange apparatus is used for an extended period of time.

The shell 10 of the conventional heat exchange apparatus is completed by cutting or grinding a thick plate primarily molded through a casting. Accordingly, coupling the tubes 20 and welding the thick plates when the thick plates are assembled in the form of a box create a complicated manufacturing process and increase manufacturing cost. In particular, the casting, cutting and grinding processes should be sequentially performed for the formation and surface process of the windings within the shell 10. Additionally, during the assembly process performed thereafter, a precise thick plate welding process should be performed for connection parts. Since, these processes are difficult to automate and require highly skilled manpower, there is a limit in mass-production of the shell 10 of the conventional heat exchange apparatus, and improvement of productivity and reduction of manufacturing cost through the mass-production are limited.

In addition, since the exterior surface of the shell 10 of the conventional heat exchange apparatus is formed of metal, the exterior surface of the shell 10 in direct contact with the heat medium including a coolant or the like is corroded. For example, deficiency in corrosion resistance of the shell 10 generates a problem in a heat exchange apparatus of an atomic power plant, a vessel or the like which uses sea water as a heat medium.

The above information disclosed in this section is merely for enhancement of understanding of the background of the invention and therefore it may contain information that does not form the prior art that is already known in this country to a person of ordinary skill in the art.

### SUMMARY

The present invention provides improve productivity and reduces manufacturing cost while securing pressure resistance and preciseness of the interior surface in a shell 10 of a heat exchange apparatus.

A heat exchange apparatus may include a plurality of tubes 20 disposed within a shell 10, through which a thermal fluid passes, in a direction perpendicular to the flow of the thermal fluid. A plurality of disk-shaped transfer fins 21 may be formed on the exterior surface of the tubes. Bonnets 30 having compartments 32 formed therein to accommodate a heat medium may be coupled to the shell 10 to connect the tubes 20 and the compartments 32 of the bonnets 30. A plurality of closure thin plates 12 may be assembled in the form of a box, and the plurality of tubes 20 may be disposed within the interior of the assembled closure thin plates 12 to couple the closure thin plates 12 having a plurality of perforated coupling apertures 13 to both ends of the tubes 20 to expose both end portions of the tubes 20 to the exterior of the closure thin plates 12. The exterior wall of the shell 10 may be formed from a synthetic resin coating layer 11 on the exterior surface of the closure thin plates 12.

According to another aspect of the present invention, a method of manufacturing the heat exchange apparatus described above may include configuring a closure thin plate 12 assembly of a box shape, in which both ends of a plurality of tubes 20 are exposed on both sides of the assembly, by assembling closure thin plates 12 to surround the tubes 20 arranged in parallel in a method of coupling closure thin plates 12 having a plurality of perforated coupling apertures 13 to both ends of the tubes 20 and coupling closure thin plates 12 having an entry-and-exit aperture 19 to both ends of the enclosure thin plate 12 assembly embedded with the tubes 20. The method may further include setting the closure thin plate 12 assembly of a box shape in a metallic mold 40 in which a mold having a shape of a shell 10 to be manufactured may be formed, in which coupling recess portions 45 having an interior diameter that correspond to the diameter of the tubes 20 are formed on the surfaces, among the interior surfaces of the metallic mold 40, parallel to both side surfaces of the closure thin plate 12 assembly of a box shape on which the tubes 20 are exposed. When the metallic molds 40 are combined, both ends of the exposed tubes 20 may be coupled to the coupling recess portions 45 of the interior surfaces of the metallic mold 40 to maintain a separated state between the surfaces of the closure thin plate 12 assembly set in the metallic mold 40 and the interior surfaces of the metallic mold 40. A coating layer 11 may be formed by injecting synthetic resin within the combined metallic mold 40, and the metallic mold 40 may be separated and removed from the shell 10 when the coating layer 11 is cured.

Through the present invention, productivity may be improved and manufacturing costs may be reduced while securing performance such as pressure resistance, airtightness and the like and durability of a heat exchange apparatus. Particularly, in configuring the shell 10 of the heat exchange apparatus, since it is possible to omit high-cost and low-productivity processes such as casting, cutting and grinding, which are essential when the shell 10 is manufactured in a conventional technique. For example, the manufacturing process and the productivity may be be drastically improved compared with the conventional technique by molding the shell 10 in multiple layers of the closure thin plate 12 formed within the interior of the shell and the synthetic resin coating layer 11 formed exterior the shell and applying the closure thin plate 12 which may easily automate and mass-produce through a press working or the like.

Additionally, when the welding is excluded or minimized in the process of manufacturing the shell 10, excessive heat transfer which may occur in welding a thick plate in the process of manufacturing the shell 10 that uses a conventional technique and defects such as deformation of the tubes 20 caused by the excessive heat transfer may be prevented. When the surface of the shell 100 directly contacting with a thermal medium such as a coolant or the like is formed of synthetic resin, further superior corrosion resistance may be secured compared with a conventional heat exchange apparatus.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIGS. 1A and 1B are exemplary view showing a conventional heat exchange apparatus of the related art;

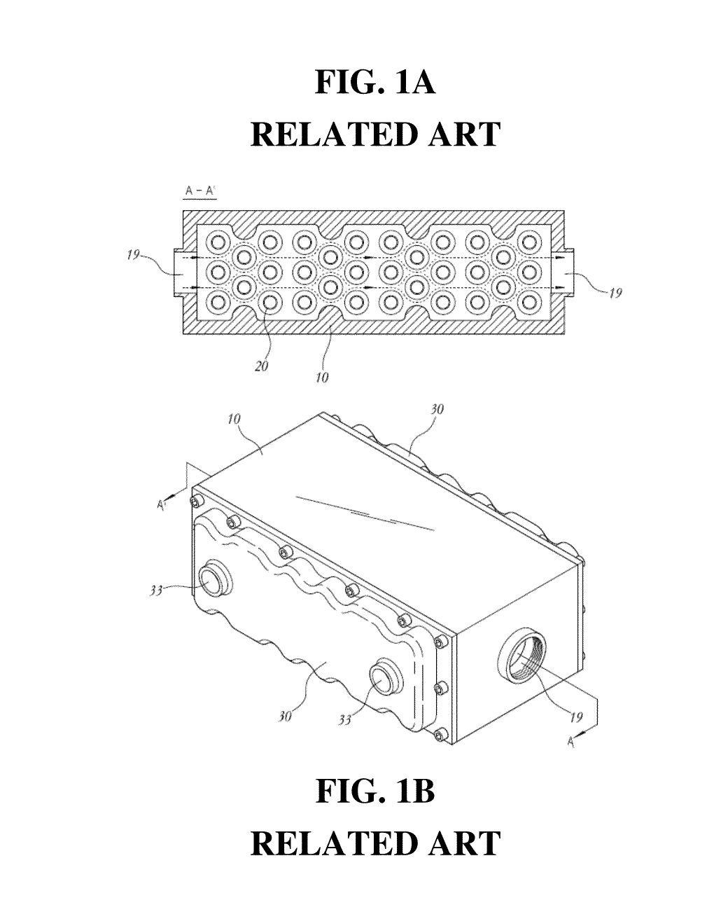

FIGS. 2A and 2B is an exemplary perspective view and a representative cross sectional view showing a heat exchange apparatus of the present invention;

FIG. 3 is an exemplary exploded perspective view showing a heat exchange apparatus according to an exemplary embodiment of the present invention;

FIG. 4 is a partially cut perspective view showing a shell according to an exemplary embodiment of the present invention;

FIG. 5 is a partially cut perspective view showing a coating layer of a shell according to an exemplary embodiment of the present invention;

FIG. 6 is an exemplary view showing an assembly method of closure thin plates according to an exemplary embodiment of the present invention;

FIG. 7 is a perspective view showing an assembly state of closure thin plates according to an exemplary embodiment of the present invention;

FIG. 8 is an exemplary view showing a metallic mold applied to an exemplary embodiment of the present invention;

FIGS. 9A and 9B are views illustrating a combined state of a metallic mold applied to an exemplary embodiment of the present invention; and

FIGS. 10A and 10B are partially cut perspective view showing an extracted shell of an exemplary embodiment of the present invention to which a reinforcing bar is applied.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The detailed configuration and process of the present invention will be hereafter described in detail with reference to the accompanying drawings.

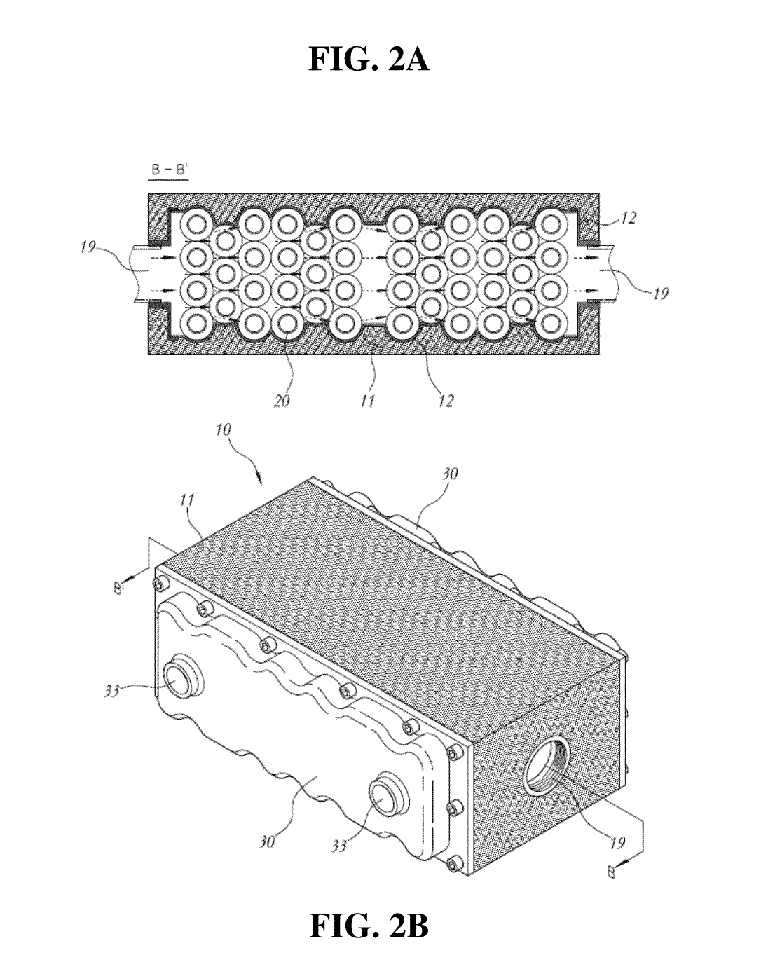

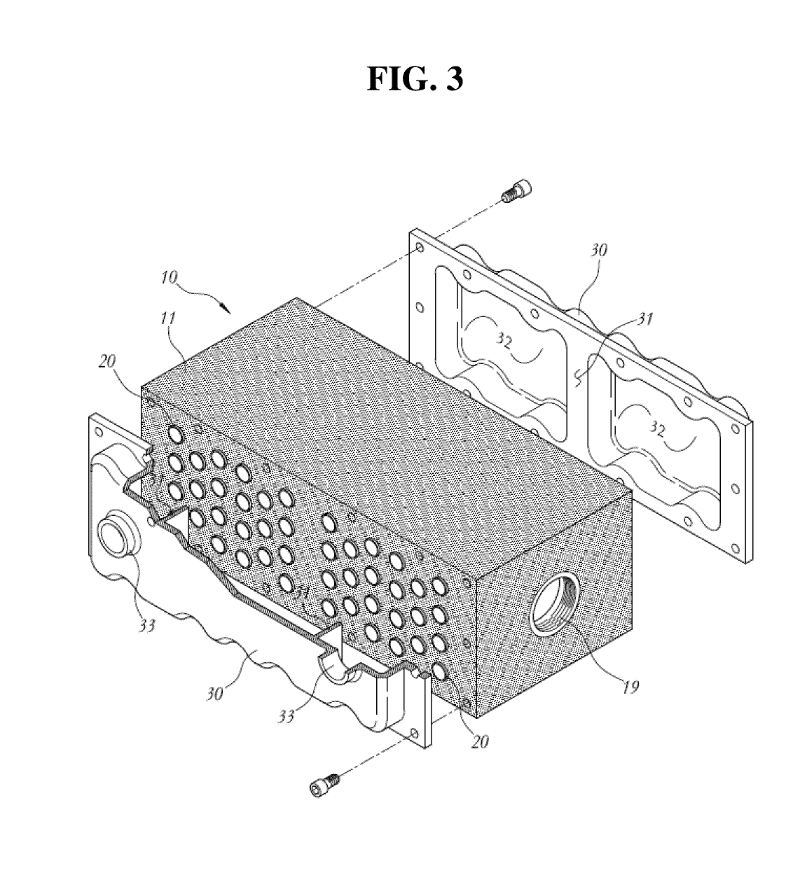

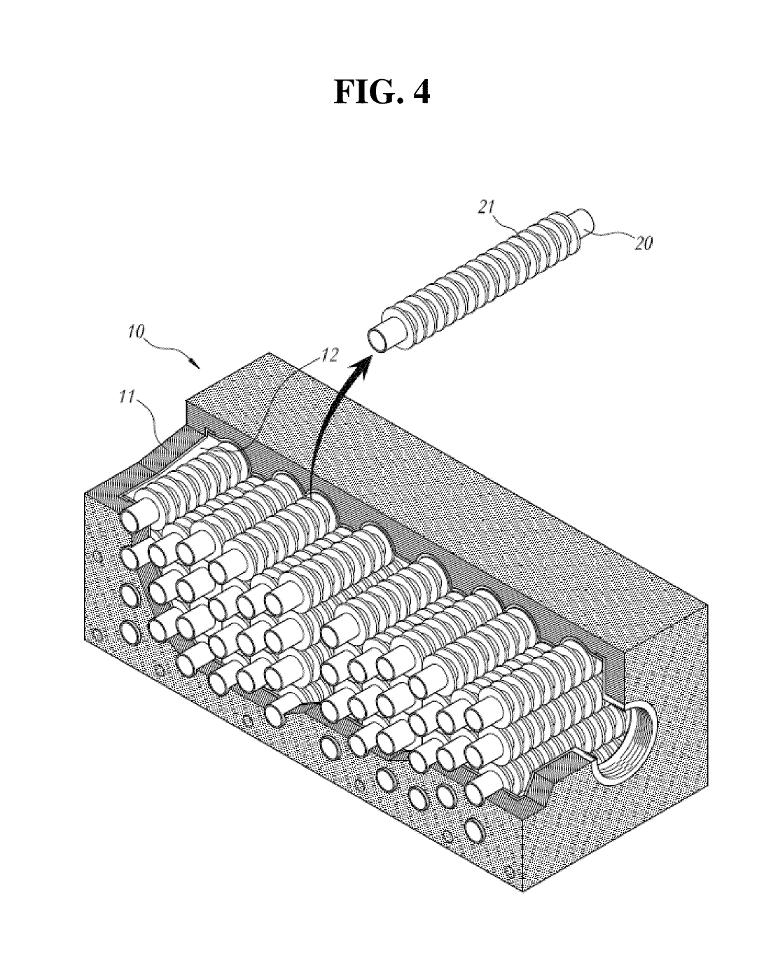

First, FIGS. 2A and 2B are show a perspective view and a representative cross sectional view showing the appearance of the heat exchange apparatus of the present invention. As shown in the figure, the heat exchange apparatus of the present invention may include a structure with a pair of bonnets 30 coupled to a shell 10, that may be a tightly sealed rectangular enclosure having an entry-and-exit aperture 19 on both of the front and rear sides, and a pair of feed-and-discharge apertures 33 formed on the bonnet 30 of one side as shown in FIG. 3. A plurality of tubes 20 having transfer fins 21 formed thereon may be disposed within the interior of the shell 10 as shown in FIG. 4.

In other words, as shown in FIGS. 2 to 4, the present invention relates to a heat exchange apparatus, in which a plurality of tubes 20 with a plurality of disk-shaped transfer fins 21 formed on the exterior surface of the tubes may be installed within a shell 10, through which a thermal fluid passes, in a direction perpendicular to the flow of the thermal fluid. Further bonnets 30 may include compartments 32 formed therein and partitioned by a partitioning wall 31 to accommodate a heat medium and may be coupled to the shell 10 to connect the tubes 20 and the compartments 32 of the bonnets 30. As shown in FIG. 4, the heat exchange apparatus may include a curved surface that repeats a plurality of valleys and peaks formed on the interior surface of the shell 10 to secure the contact efficiency between the thermal fluid and the tubes 20.

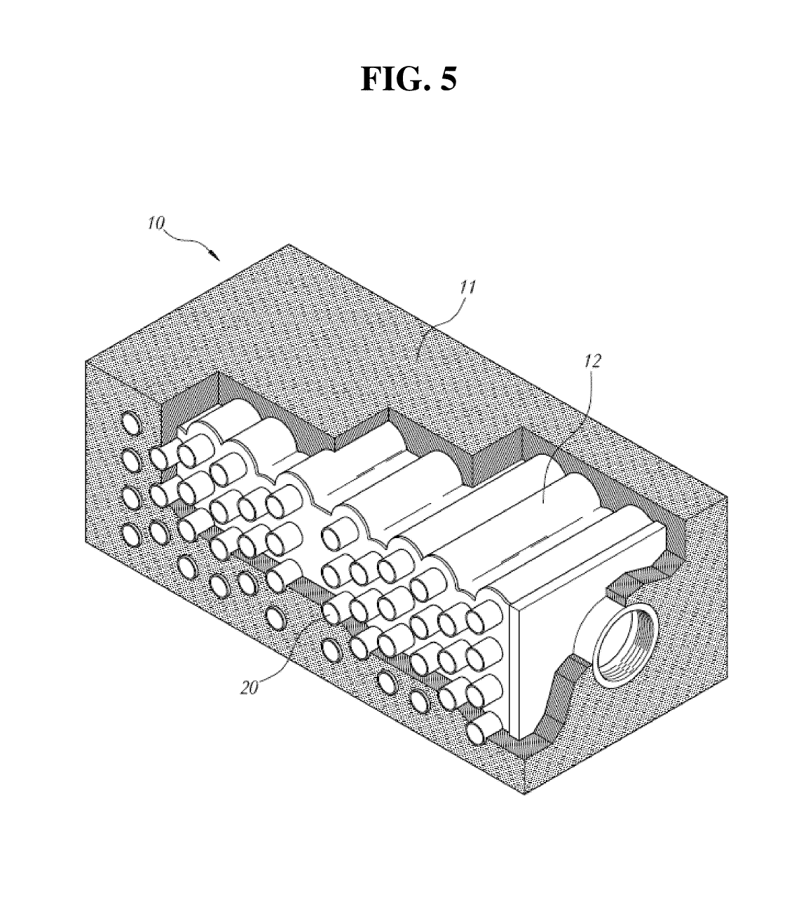

In the heat exchange apparatus, since the shell 10 provides a pressure container through which high pressure thermal fluid passes, the pressure resistance, as well as high degree airtightness should be included. Further, the present invention, as shown in FIGS. 4 and 5, the shell 10 may be formed by coating the exterior of the metal closure thin plates 12 with a synthetic resin coating layer 11. In other words, the shell 100 of a multiple layer structure may be formed by stacking the synthetic resin coating layer 11 on the exterior surface of the closure thin plates 12 embedded with the tubes 20 and assembled in the form of a box.

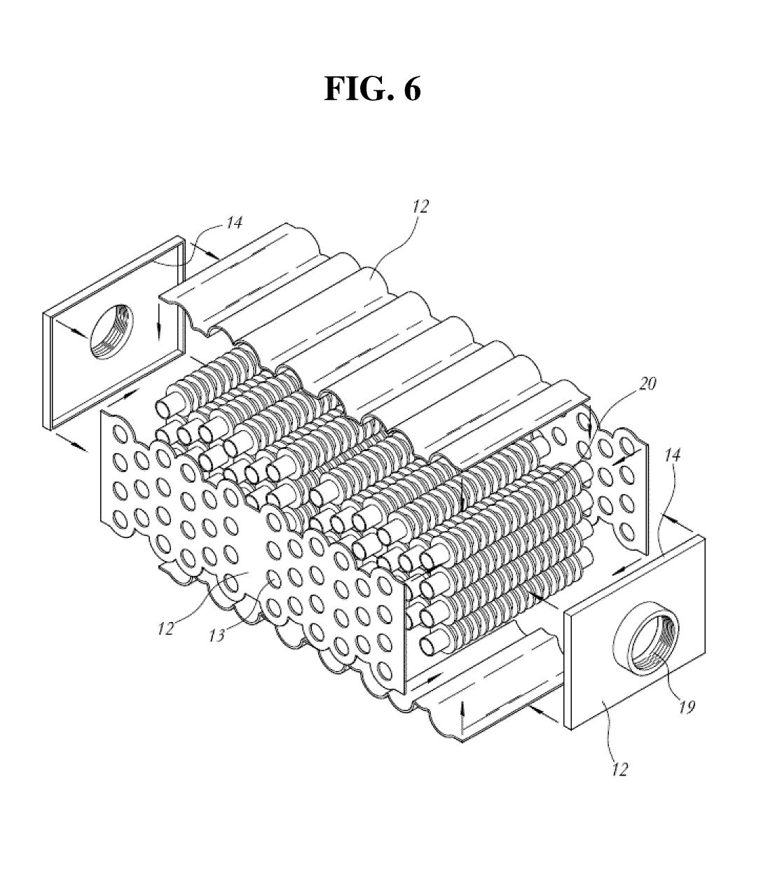

The closure thin plate 12 of the present invention may include a metal plate that forms the interior wall of the shell 10 and may be primarily coupled with the tubes 20. A plurality of unit closure thin plates 12 may be assembled in the form of a box as shown in FIG. 6. In the exemplary embodiment shown, a curved surface repeating valleys and peaks may be formed on the top and bottom closure thin plates 12, and coupling apertures 13 of the same number and the same positions to correlate with those of the tubes 20 may be perforated on the closure thin plates 12 of both sides, and the entry-and-exit aperture 19 may be formed on the closure thin plates 12 of the front and rear sides.

Additionally, connection parts between the closure thin plates 12 may be bent and cut in an identical form. For example, when the closure thin plates 12 are assembled in the form of a box, the connection parts may be tightly coupled, and the interior of the assembled closure thin plates 12 may be tightly sealed.

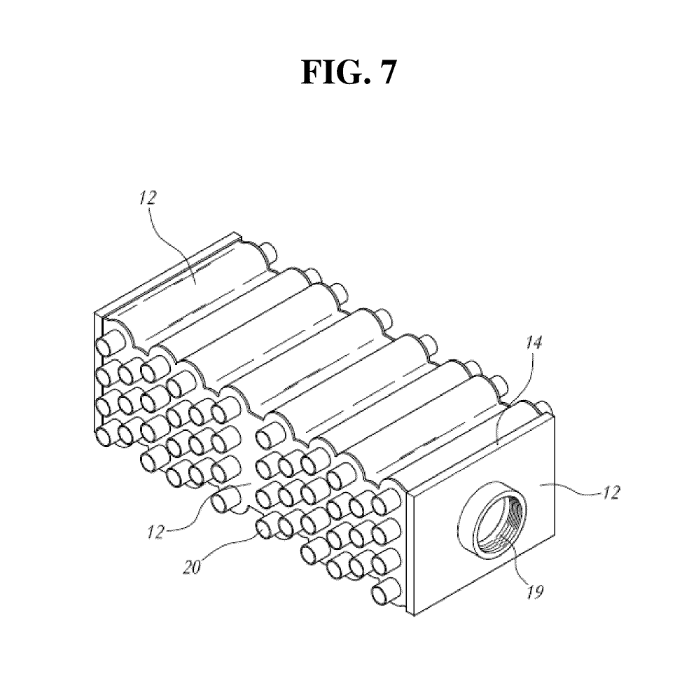

In other words, as shown in FIGS. 6 and 7, a curved surface may be formed on the top and bottom sides of the closure thin plate 12 assembly. Further, the top and bottom portions of the closure thin plates 12 may include a plurality of perforated coupling apertures 13 and may be tightly coupled to both side ends of the top and bottom side closure thin plates 12 in a shape the same as the windings of the curved surface of the top and bottom side closure thin plates 12. Thus when the closure thin plates 12 are assembled, the connection parts are tightly coupled, and the interior of the assembled closure thin plates 12 may be tightly sealed.

The closure thin plates 12 of the present invention are assembled in the form of a box while the tubes 20 are embedded therein. In other words both ends of the tubes 20 may be coupled to the coupling apertures 13 formed on the closure thin plates 12 of both sides in the assembly process. Thus both ends of the tubes 20 may be exposed on both sides of the closure thin plate 12 assembly as shown in FIG. 7.

Additionally, as shown in FIG. 6, coupling steps 14 protruded toward the interior may be formed along the exterior periphery of the closure thin plates 12 of the front and rear sides. The closure thin plates formed with the coupling step 14 may be coupled to the front and rear sides of the assembly formed by assembling the closure thin plates 12 of both sides and the top and bottom sides as shown in FIG. 7. Thus the closure thin plates 12 may be firmly combined in the form of a box without a separate process such as adhering, welding or the like. As described above, the closure thin plates 12 of the present invention may be manufactured by processing a metal plate. In particular, the process of forming the curved surface, cutting the exterior periphery and perforating the coupling apertures 13 may be performed when a press working is applied. For example, through the press working applied to the closure thin plates 12, the present invention may secure productivity remarkably improved compared with the conventional technique which requires a series of complicated processes that include casting, cutting, grinding and the like.

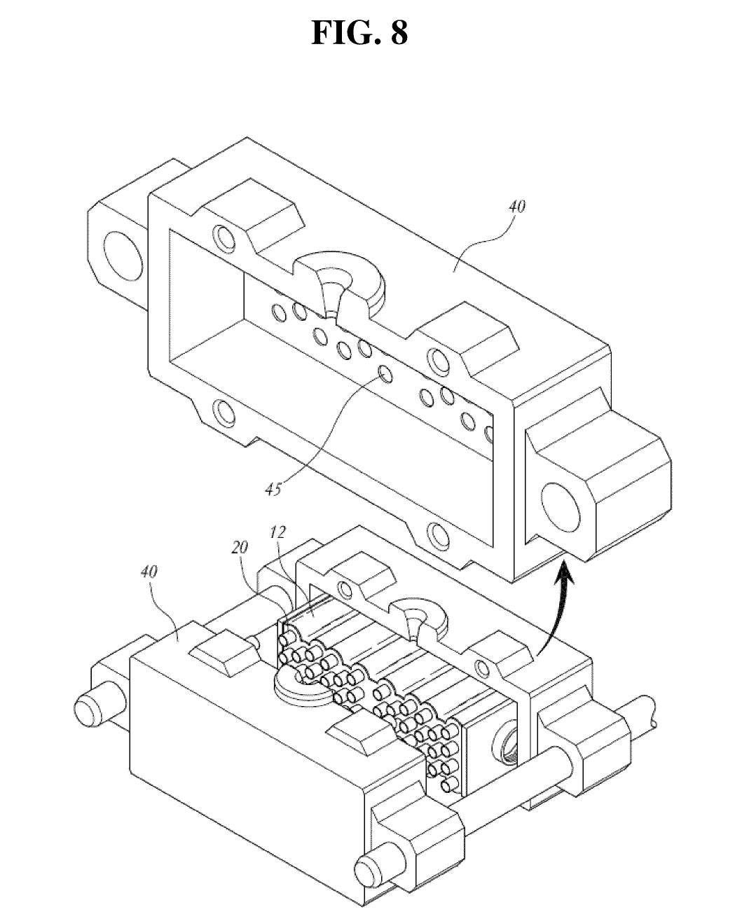

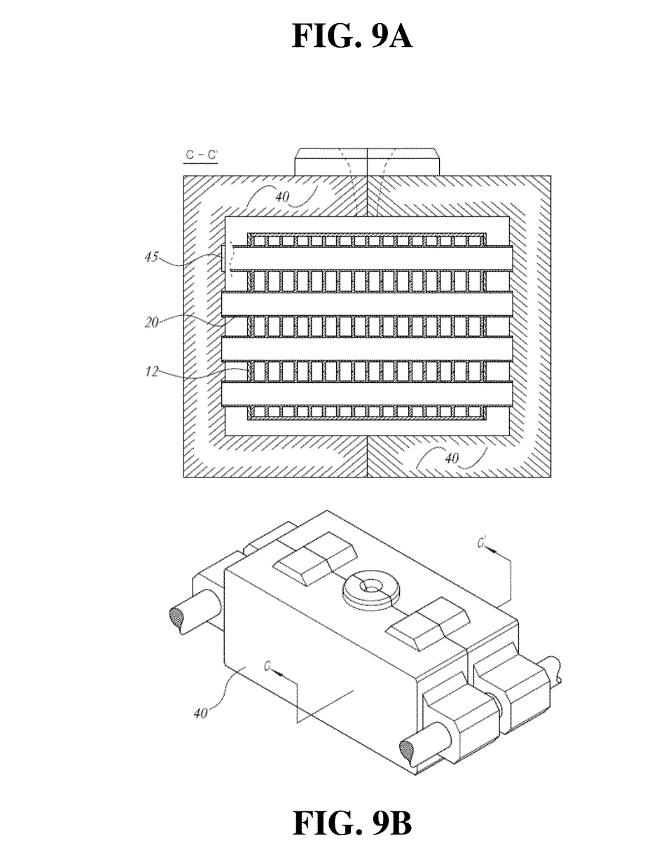

As described above, airtightness and pressure resistance may be provided to the shell 10 by stacking the synthetic resin coating layer 11 on the exterior surface of the closure thin plate 12 assembly embedded with the tubes 20 and assembled in the form of a box as shown in FIG. 5. For example, this may be accomplished through an injection molding method using a combination type metallic mold 40 as shown in FIGS. 8 and 9A and 9B.

A method of manufacturing a heat exchange apparatus of the present invention includes configuring a closure thin plate 12 assembly of a box shape, in which both ends of a plurality of tubes 20 may be exposed on both sides of the assembly as shown in FIG. 7. For example, the closure thin plates 12 may be assembled to surround the tubes 20 arranged in parallel in a method of coupling closure thin plates 12 having a plurality of perforated coupling apertures 13 to both ends of the tubes 20 and coupling closure thin plates 12 having an entry-and-exit aperture 19 to both ends of the enclosure thin plate 12 assembly embedded with the tubes 20.

Then, as shown in FIG. 8, the closure thin plate 12 assembly of a box shape in the metallic mold 40 in which a mold having a shape of a shell 10 to be manufactured may be formed. As, shown in the extracted expansion portion of the figure, coupling recess portions 45 may have an interior diameter that corresponds to the diameter of the tubes 20 formed on the surfaces, among the interior surfaces of the metallic mold 40, parallel to both side surfaces of the closure thin plate 12 assembly of a box shape on which the tubes 20 are exposed. When the metallic molds 40 are combined, both ends of the exposed tubes 20 may be coupled to the coupling recess portions 45 of the interior surfaces of the metallic mold 40 to maintain a separated state between the surfaces of the closure thin plate 12 assembly set in the metallic mold 40 and the interior surfaces of the metallic mold 40.

In order to simultaneously form the synthetic resin coating layer 11 on the entire exterior surface, i.e., six sides, of the closure thin plate 12 assembly of a box shape, a state of separating the closure thin plate 12 assembly from the interior wall of the metallic mold 40 may be be maintained in the metallic mold 40. Accordingly, a spacer that supports the closure thin plate 12 assembly, that may be an inserted object, within the metallic mold 40 should be installed to maintain the separated state. The spacer may degrade performance such as strength, airtightness, pressure resistance and the like, as well as the exterior appearance of a completed mold product.

Therefore, in the present invention, the spacer may be excluded, and the coupling recess portions 45 having an interior diameter the same as the diameter of the tube 20 are formed on the both interior surfaces of the metallic mold 40 to have the same number and the same positions as those of the tubes 20 exposed on both sides of the closure thin plate 12 assembly. Thus when the metallic molds 40 are combined, both ends of the exposed tubes 20 may be coupled to the coupling recess portions 45 of the interior surfaces of the metallic mold 40 to maintain a separated state between the surfaces of the closure thin plate 12 assembly set in the metallic mold 40 and the interior surfaces of the metallic mold 40 as shown in FIGS. 9A and 9B.

In other words, as shown the cross-sectional view shown in the upper portion of FIG. 9A, flow of melt synthetic resin injected within the interior of the metallic mold 40 into the tubes 20 may be prevented by accurately and stably maintaining the position of the closure thin plate 12 assembly disposed within the metallic mold 40 when the molding is processed and tightly close the openings on both ends of the tubes 20.

As described above, the shell 10 of a multi-layer structure may be completed by performing the step of forming the coating layer 11 by injecting synthetic resin within the interior of the combined metallic mold 40 when the closure thin plate 12 assembly is stably set within the interior of the metallic mold 40. The metallic mold 40 may be separated and removed from the shell 10 when the coating layer 11 is cured. Thereafter, as shown in FIG. 3, a heat exchange apparatus to which the present invention is applied may be completed by attaching the bonnets 30 on both sides of the shell 10.

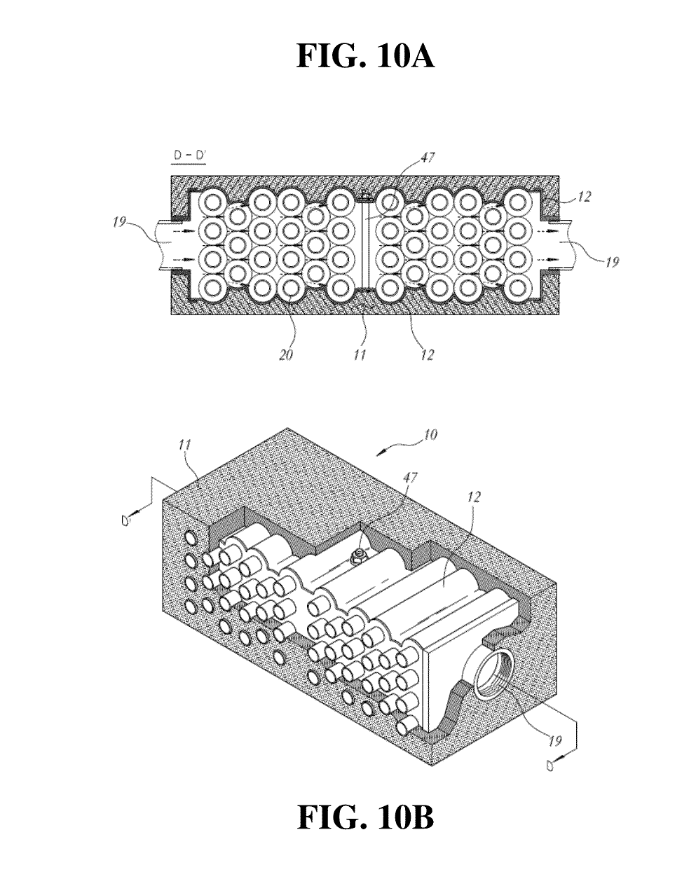

Moreover as shown in FIGS. 10A and 10B FIG. 10 views showing an embodiment of coupling a reinforcing bar 47 to the closure thin plate 12 assembly of the present invention. The exemplary embodiment, illustrates that bonding strength of the closure thin plate 12 assembly may be secured, and in addition, pressure resistance of the completed shell 10 may be improved when the reinforcing bar 47 is inserted in the assembly and the metallic mold 40.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

1. A heat exchange apparatus comprising:
a plurality of tubes disposed within an interior a shell through which a thermal fluid passes, disposed in a direction perpendicular to flow of the thermal fluid and having a plurality of disk-shaped transfer fins formed on an exterior surface of the tubes; and
a plurality of bonnets having a compartment formed therein to accommodate a heat medium and coupled to the shell to connect the plurality of tubes and the compartment of the bonnets, wherein
a plurality of closure thin plates are formed in a box shape, and the plurality of tubes are disposed within assembled closure thin plates,
wherein the closure thin plates having a plurality of perforated coupling apertures are coupled to both ends of the tubes to expose both end portions of the tubes to an exterior of the closure thin plates, and an exterior wall of the shell is formed by a synthetic resin coating layer disposed on an exterior surface of the closure thin plates.

2. The apparatus of claim 1, wherein the bonnet includes a plurality of bonnets disposed in a direction perpendicular to the flow of the thermal fluid.

3. The apparatus of claim 1, wherein the bonnet include a plurality of compartments.

4. The apparatus of claim 3, wherein the bonnet includes a compartment wall disposed between the plurality of compartments.

5. The apparatus of claim 1, wherein the bonnets contain an apertures to couple the bonnet to the shell via a screw.

6. The apparatus of claim 1, wherein feed and discharge apertures are disposed in the bonnet.

7. The apparatus of claim 7, wherein the feed and discharge apertures are disposed in a direction perpendicular to the flow of the thermal fluid.

8. The apparatus of claim 4, wherein the compartment wall is adjacent to feed and discharge apertures.

9. The apparatus of claim 1, wherein the plurality of tubes are disposed within the interior of the shell in an offset and a layered arrangement.

10. The apparatus of claim 1, wherein the synthetic resin coating layer may be a multi-layer structure.

11. The apparatus of claim 1, wherein the closure thin plate includes a curved surface on a top closure thing plate and a bottom closure thin plate.

12. The apparatus of claim 1, wherein the coupling apertures have the same number and same position as the plurality of tubes.

13. The apparatus of claim 1, wherein a closure thin plate disposed to surround an entry and exit aperture has a coupling step that protrudes toward the interior of the shell.

14. A method of manufacturing a heat exchange apparatus of claim 1, the method comprising:
configuring a closure thin plate assembly of a box shape, with both ends of a plurality of tubes are exposed on both sides of the assembly, by assembling closure thin plates to surround the tubes arranged in parallel in a method of coupling closure thin plates having a plurality of perforated coupling apertures to both ends of the tubes 20 and coupling closure thin plates having an entry-and-exit aperture to both ends of the enclosure thin plate assembly embedded with the tubes;
setting the closure thin plate assembly of a box shape in a metallic mold in which a mold having a shape of a shell is formed,
wherein coupling recess portions having an interior diameter corresponding to a diameter of the tubes are formed on surfaces, among interior surfaces of the metallic mold, parallel to both side surfaces of the closure thin plate assembly of a box shape on which the tubes are exposed, and
wherein the metallic molds are combined, both ends of the exposed tubes are coupled to the coupling recess portions of the interior surfaces of the metallic mold to maintain a separated state between the surfaces of the closure thin plate assembly disposed in the metallic mold and the interior surfaces of the metallic mold;
forming a coating layer by injecting synthetic resin within the combined metallic mold 40; and
separating the metallic mold and removing the shell when the coating layer is cured.
